(19) United States
(12) Patent Application Publication
(10) Pub. No.: US 2002/0170790 A1
(43) Pub. Date: Nov. 21, 2002

(54) Elevator safety brake

(76) Inventor: Roy J. Walker, Bartlett, TN (US)

Correspondence Address: WHITE & CASE LLP, PATENT DEPARTMENT, 1155 AVENUE OF THE AMERICAS, NEW YORK, NY, 10036, US

(21) Appl. No.: 10/052,683

(22) Filed: Jan. 18, 2002

Related U.S. Application Data
(60) Provisional application No. 60/262,727, filed on Jan. 18, 2001.

(51) Int. Cl. F16D 69/00

(52) U.S. Cl. 188/250 R

(57) ABSTRACT

The present invention provides an elevator safety brake pad and elevator safety brake pad assembly for use in high-speed, high-load elevators. The brake pad is preferably manufactured from a carbon metallic material and may have a burnished finish. The pad provides a consistent coefficient of friction that does not deteriorate with use. Also disclosed is an elevator safety brake wedge that is suitable for use with the elevator safety brake pad and safety brake pad assembly.

This application claims the benefit of U.S. Provisional Application No. 60/262,727, filed on Jan. 18, 2001, which is hereby incorporated in its entirety by reference.

### BACKGROUND OF INVENTION

1. Field of the Invention

The present invention relates to elevator systems that employ safety brakes. In particular, the present invention provides an elevator safety brake pad and brake pad assembly for use with a conventional elevator safety brake wedge, as well as for use with an improved safety brake wedge.

2. Description of the Related Art

As buildings become taller and more congested, elevators must operate at higher speeds and carry greater numbers of passengers. An elevator's safety braking system limits an elevator car's operating speed and load. Should a cable break, a hydraulic jack fail, a controller malfunction, or some other failure occur, the elevator safety brake system must safely and effectively stop the elevator from free falling, which could cause serious injury to passengers and significant damage to the elevator system. In a typical elevator system, an elevator car rides up and down in an elevator shaft along guide rails. To stop an elevator car in an emergency, a safety brake wedge, which is attached to the elevator car, engages one or more guide rails. Friction between the guide rail and a rail-facing surface on the safety brake wedge, provides a stopping force sufficient to stop the elevator car's motion. Thus, a major limitation to an elevator emergency brake system is the coefficient of friction between the rail-facing surface of the elevator safety brake wedge and the guide rail.

The rail-facing surface of a conventional elevator safety brake wedge is made from cast iron. One shortcoming of the cast iron surface is that it has a relatively low coefficient of friction at high speeds. In general, as speed increases, the amount of frictional heat generated also increases, and, for most materials, heat generally deteriorates their coefficients of friction. At high speeds, e.g., above 1000 fpm, the cast iron surface of a standard elevator safety brake wedge may begin to melt. This melting significantly deteriorates the cast iron's coefficient of friction.

In order to stop a 15,000 pound elevator car traveling at 2000 fpm within 50 ft (approximately 0.5 gs), the industry standard, a stopping force of 22,455 lbs is needed, and this typically requires that the elevator safety brake pad have a coefficient of friction of 0.16, with respect to the guide rail. Cast iron brake pads are unsuitable for use in high speed applications because of their low coefficient of friction.

In effort to address the need for a high coefficient of friction at high speeds and loads, one manufacturer employs plasma spray coated brake pads. Plasma coated materials, while having high initial coefficients of friction, have certain drawbacks. A plasma coated brake pad has an extremely hard surface, which quickly deteriorates elevator guide rails. More significantly, however, the coefficient of friction of a plasma coated pad with respect to an elevator guide rail decreases with use because it becomes clogged with steel from the elevator guide rail. Thus, a need exists for an elevator safety brake pad that maintains a high coefficient of friction at high speeds and that does not lose its high coefficient of friction with repeated use.

### SUMMARY OF THE INVENTION

The present invention provides an elevator safety brake pad assembly that is particularly useful in high-speed elevators. Of course, the assembly may be used in any elevator system that employs a safety brake system. The safety brake pad assembly comprises an elevator safety brake pad. The brake pad may be manufactured from standard friction materials. A carbon metallic friction material, such as Performance Friction Compound 95® (manufactured by Performance Friction, 83 Carbon Metallic Way, Clover S.C. 29710) is preferred. The brake pad has a mounting surface for engaging a backing plate or for engaging directly an elevator safety brake wedge and a sliding surface for engaging an elevator guide rail. The sliding surface may have a burnished finish that provides a constant coefficient of friction with respect to the elevator guide rail, during an initial braking application, i.e., an initial slide. Moreover, for subsequent slides—under conditions of similar load and speed—the coefficient of friction between the elevator guide rail and the sliding surface of the brake pad does not significantly vary from the coefficient of friction for the initial slide, and during subsequent slides the coefficient of friction remains relatively constant. The safety brake pad assembly also comprises an elevator safety brake pad backing plate. The backing plate has a wedge-mounting surface for engaging an elevator safety brake wedge and a pad-mounting surface on which the elevator safety brake pad is mounted. The pad may be mounted to the backing plate with conventional means, such as cement and/or mechanical fasteners, e.g. rivets.

The elevator brake pad assembly may be used with a standard elevator safety brake pad device, such as an elevator safety brake wedge, or it may be used with an improved safety brake wedge. The improved safety brake wedge comprises a top surface, a bottom surface, an inclined surface and a rail-facing surface. The top and bottom surfaces are parallel to each other and the inclined surface intersects the bottom surface at an acute angle and intersects the top surface at an obtuse angle. The rail-facing surface intersects the bottom surface at a right angle and is perpendicular to the top surface. A shoulder protrudes normally from the rail-facing surface. An elevator safety brake pad or elevator safety brake pad assembly, such as the one described above, may be secured to the rail-facing surface below and adjacent to the shoulder with standard fastening means, such as mechanical fasteners. In applications where the brake pad or brake pad assembly abuts the shoulder from below, the shoulder assists the mechanical fasteners in securing the brake pad or brake pad assembly to the safety wedge by carrying a portion of any shear forces that are generated on the brake pad or brake pad assembly during a slide.

### BRIEF DESCRIPTION OF THE DRAWINGS

FIG. 1A is a perspective view of an elevator brake pad according to the present invention.

FIG. 1B is a side view of the elevator brake pad.

FIG. 2A is a perspective view of an elevator brake pad assembly according to the present invention.

FIG. 2B is a side view of an elevator safety brake pad backing plate that is used in the elevator brake pad assembly of the present invention.

FIG. 3 illustrates an improved safety brake wedge according to the present invention.

FIG. 4 illustrates an improved safety brake wedge having the elevator brake pad assembly of the present invention mounted thereto.

FIG. 5 is a graph illustrating the relationship of the coefficient of friction between the elevator guide rail and a safety brake pad to initial sliding velocities.

### DETAILED DESCRIPTION OF THE INVENTION

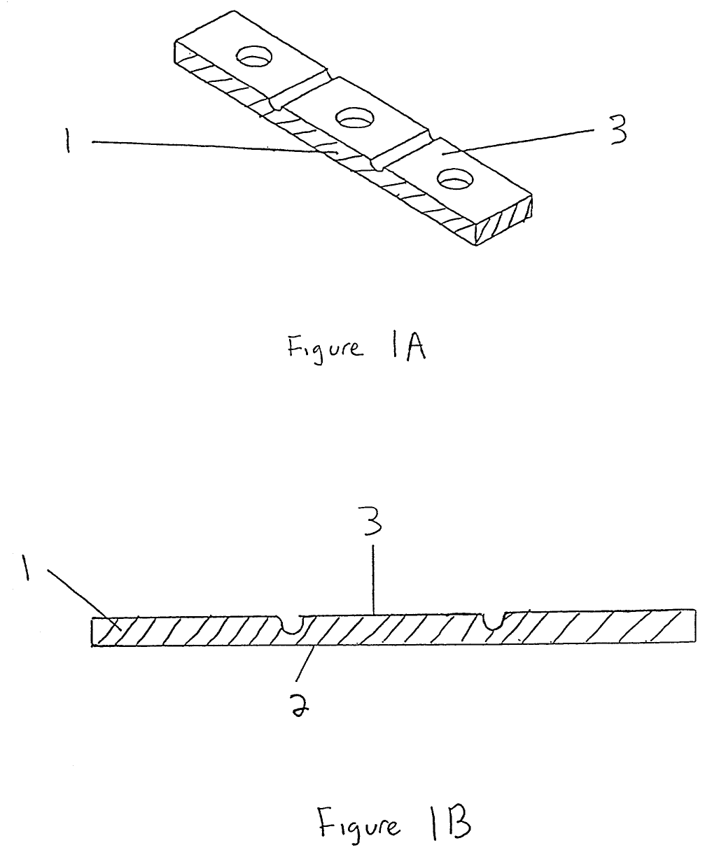

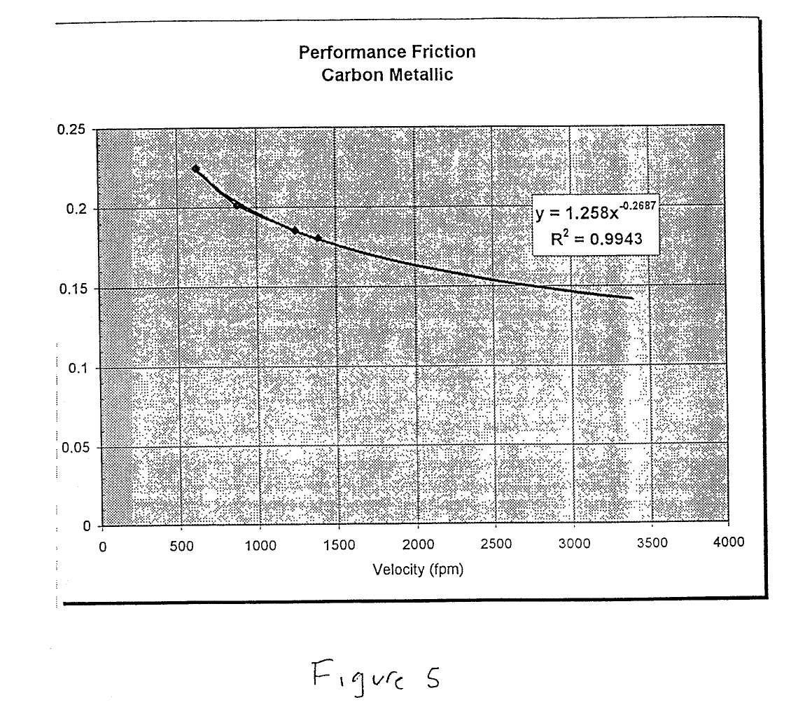

Referring to FIGS. 1A and 1B, a carbon metallic friction material, such as Performance Friction's Compound 95®, is formed into an elevator safety brake pad 1. The elevator safety brake pad 1 has a mounting surface 2 for engaging a backing plate or for engaging directly an elevator safety brake wedge. The elevator safety brake pad 1 also has a sliding surface 3 for engaging an elevator guide rail (not shown), which is typically a steel rail. The sliding surface 3 preferably has a burnished finish. A laser burnishing process is particularly well suited for burnishing the sliding surface, but other burnishing processes may be employed. The sliding surface 3 has a coefficient of friction when engaging an elevator guide rail that remains relatively constant during a slide. Moreover, the coefficient of friction between an initial slide and subsequent slides, under conditions of similar load and speed, remains relatively constant. For any given slide, the coefficient of friction is a function of the elevator safety brake pad's velocity when it engages an elevator guide rail and for a fixed load of 15,190 lbs is approximately defined by the following equation, which is graphically illustrated in FIG. 5:

$$μ = 1.258 * {v}^{- 0.2687}$$

For other loads the coefficient of friction is believed to be defined by a similar equation.

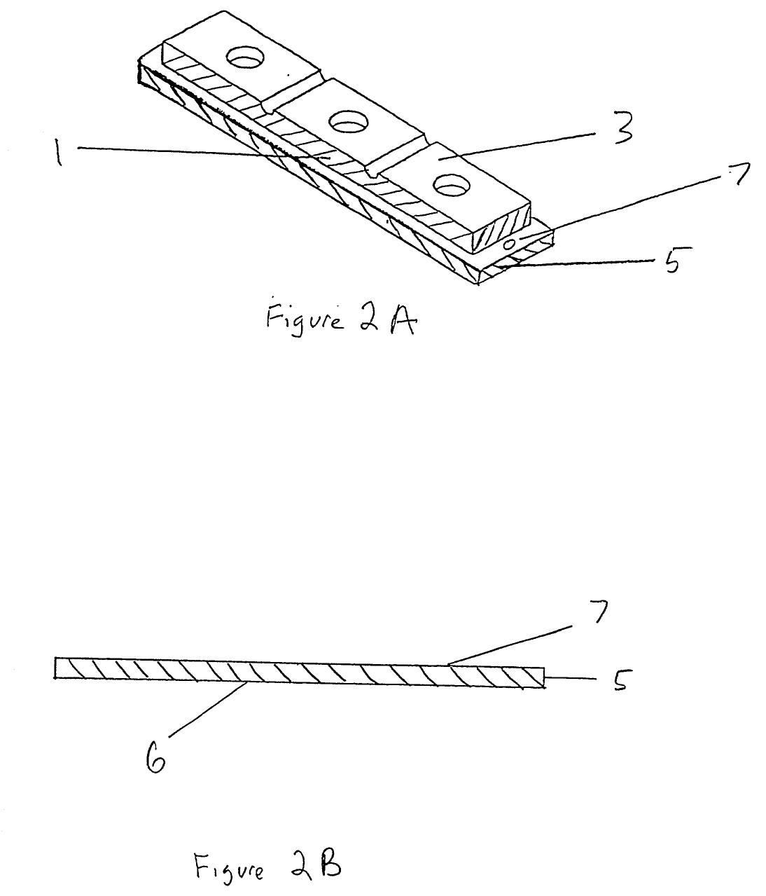

The elevator safety brake pad described above may be directly mounted directly on an elevator safety wedge, or may be secured to a backing plate 5 that is mounted to an elevator safety wedge (see FIGS. 2A and 2B). It may be mounted with conventional mechanical fasteners and/or cement. The backing plate has a wedge-mounting surface 6 for engaging an elevator safety wedge and a pad-mounting surface 7 on which the elevator safety brake pad 1 may be mounted. The elevator safety brake pad 1 may be mounted on the pad-mounting surface with conventional means, such as cement or mechanical fasteners. The elevator safety brake pad 1 when mounted on the backing plate may be referred to as an elevator safety brake pad assembly.

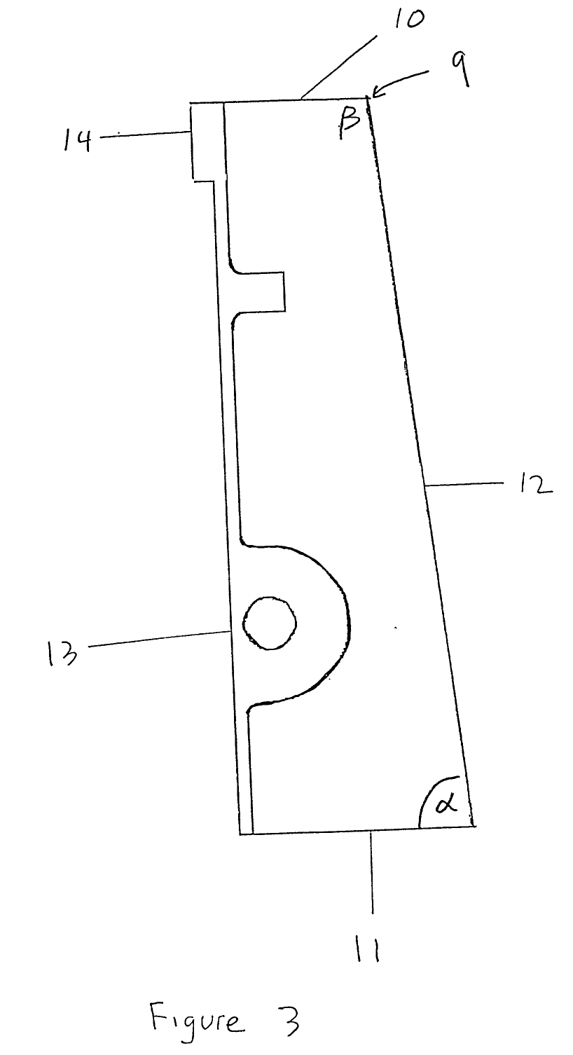

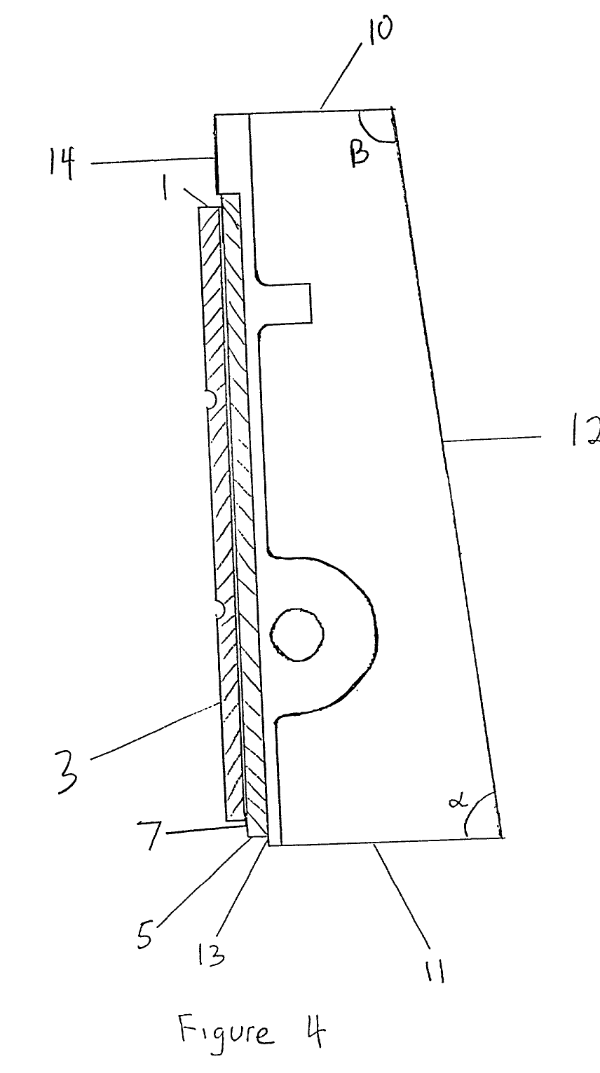

The brake pad assembly may be used with a standard elevator safety brake wedge, or it may be used with an improved elevator safety brake wedge 9 shown in FIG. 3. The improved brake wedge 9 has top and bottom surfaces 10 and 11 respectively, that are parallel to each other. The improved brake wedge 9 has an inclined surface 12 that intersects the bottom surface 11 at an acute angle α and intersects the top surface 10 at an obtuse angle β. The improved brake wedge also has a rail-facing surface 13 that intersects the bottom surface 11 at a right angle and is perpendicular to the top surface 10. A shoulder 14 (which may take many forms including the form of a tab as shown in the drawings) for carrying braking force shear loads protrudes normally away from the rail-facing surface 13. In applications where an elevator safety brake pad or safety brake pad assembly is mounted on the rail-facing surface 13 below and adjacent to the shoulder 14 (see FIG. 4), the shoulder 14 helps to secure the pad or assembly to the wedge during a slide by carrying a portion the shear loads that are generated on the elevator safety brake pad 1 or elevator safety brake pad assembly.

The elevator safety brake pad, elevator safety brake pad assembly, and the improved safety brake wedge disclosed herein are useful in a variety of elevator systems. In particular, the invention disclosed herein is well suited for use in high-speed high load elevator systems that may encounter speeds in excess of 18,000 lbs at 2000 fpm. The example below is intended to illustrate some of the properties of the brake pad of the present invention, but is not intended to limit the present invention to materials and conditions of use set forth therein.

### EXAMPLE 1

An elevator safety brake pad assembly manufactured from Performance Friction Compound 95® was used with an improved elevator safety brake pad wedge. The assembly had a configuration similar to that shown in FIG. 4. The brake pad has a surface area of 6.25 square inches. A load force of 15,190 lbs. was dropped and brought to a stop by engaging the safety brake pad with a steel guide rail. Table 1 sets forth data relating to the pad's coefficient of friction. As used in Table 1, “Drop Ht, h₁” refers to the distance the pad and load were allowed to free fall before the elevator safety brake pad engaged an elevator guide rail. “Slide h₂” refers to the distance that was required to bring the load and pad to a stop after the pad engaged the rail. “Normal Force” refers to the normal force exerted on the elevator safety brake pad and contact pressure is the normal force on the elevator safety brake pad divided by its area. “Coefficient of friction μ” refers to the average sliding coefficient of friction of the pad. “Test Speed” refers to the speed at which the pad and load were traveling when the pad engaged the rail. “Deceleration” refers to the average deceleration rate of the elevator safety brake pad and load after the safety brake pad engages the guide rail.

TABLE 1

| | | | | | | Test | Contact |
|---|---|---|---|---|---|---|---|
| Test | Drop Ht | Slide | Deceleration | Normal Force | Coef. | Speed | Pressure |
| No. | h₁ (in.) | h₂ (in.) | (g's) | (lbs) | μ | (fpm) | (psi) |
| 1 | 20 | 20.41 | 0.9799 | 33,462 | 0.225 | 621.61 | 5353.92 |
| 2 | 40 | 51.66 | 0.7743 | 33,462 | 0.201 | 879.09 | 5353.92 |
| 3 | 80 | 126 | 0.6349 | 33,462 | 0.186 | 1243.22 | 5353.92 |
| 4 | 100 | 169 | 0.5917 | 33,462 | 0.181 | 1389.96 | 5353.92 |
| 5 | 20 | 24.99 | 0.8003 | 33,462 | 0.204 | 621.21 | 5353.92 |

What is claimed is:

1. An elevator safety brake pad assembly comprising:
a carbon metallic elevator safety brake pad, the carbon metallic elevator safety brake pad comprising:
a mounting surface for engaging a backing plate;
a sliding surface for engaging an elevator guide rail, the sliding surface having a burnished finish and having a relatively constant coefficient of friction when engaging and sliding along the elevator guide rail during an initial slide, and wherein the average coefficient of friction for subsequent slides, under conditions of similar load and speed, remains relatively constant; and
an elevator safety brake backing plate having a wedge-mounting surface for engaging and mounting an elevator safety wedge and a pad-mounting surface on which the carbon metallic elevator safety brake pad is mounted.

2. The elevator safety brake pad assembly of claim 1 wherein the coefficient of friction for a constant load is approximately defined by the following equation:
$$μ = 1.258 * {v}^{- 0.2687}$$
wherein v=the velocity of the brake pad assembly when it first engages the elevator guide rail.

3. An elevator safety braking system comprising:
an elevator brake wedge comprising:
a top surface;
a bottom surface, the bottom surface generally parallel with the top surface and located below the top surface;
an inclined surface intersecting the top surface at an obtuse angle and intersecting the bottom surface at an acute angel;
a rail-facing surface intersecting the top and bottom surfaces at approximately a right angle; and
a tab extending normally away from the rail-facing surface for absorbing shear loads from an elevator brake pad;
a brake pad backing plate, the brake pad backing plate having a pad-mounting surface for mounting a brake pad and a wedge-mounting surface for engaging the rail-facing surface of the elevator brake wedge, the brake pad backing plate mounted along the rail-facing surface of the elevator brake wedge below the tab;
a carbon metallic brake pad for engaging a steel elevator guide rail comprising:
a mounting backing surface for engaging the backing plate, and
a sliding surface for engaging an elevator guide rail, the sliding surface having a burnished finish, the sliding surface also having an approximately constant coefficient of friction when sliding against the rail during an initial slide,
wherein the coefficient of friction for subsequent slides between subsequent braking applications remains relatively constant.

4. An elevator safety brake pad assembly comprising:
an elevator brake wedge, the elevator brake wedge having a rail-facing surface;
a brake pad backing plate, the brake pad backing plate having a pad-mounting surface for mounting an elevator safety brake pad and a wedge-mounting surface that engages the elevator brake wedge along the rail-facing surface;
a carbon metallic brake pad for engaging an elevator guide rail, the carbon metallic brake pad being mounted to the backing plate and comprising a sliding surface for engaging an elevator guide rail, the sliding surface having a burnished finish.

5. The elevator brake pad assembly of claim 4, wherein the sliding surface, when engaging an elevator guide rail, has an average coefficient of friction for a fixed load during a slide approximately defined by the following equation:
$$μ = 1.258 * {v}^{- 0.2687}$$
wherein v=the velocity of the brake pad assembly when it first engages the elevator guide rail.

6. A carbon metallic elevator safety brake pad for engaging an elevator guide rail comprising
a mounting surface for engaging a backing plate; and
a sliding surface for engaging the elevator guide rail, the sliding surface having a shape complementary to the elevator guide rail, the sliding surface also having a burnished finish, the sliding surface further having an approximately constant coefficient of friction when sliding against the elevator guide rail during an initial slide,
wherein the coefficient of friction for subsequent slides remains relatively constant, under conditions of similar speed and loads.

7. The carbon metallic elevator safety brake pad of claim 6, wherein the burnished finish is a street car brake pad burnished finish.

8. The elevator safety brake pad of claim 6, wherein the burnished finish is a laser burnished finish.

9. The elevator safety brake pad of claim 6, wherein the coefficient of friction (p) between the rail and the carbon metallic elevator safety brake pad is approximately defined approximately by the following equation:
$$μ = 1.258 * {v}^{- 0.2687}$$
for an elevator having a load of approximately 15,000 lbs,
wherein v=the velocity of the brake pad assembly when it first engages the elevator guide rail.

10. An elevator braking apparatus comprising:
a pad mounting structure having a rail-facing surface for facing an elevator rail;
a shoulder protruding from the rail-facing surface;
and a fiction pad mounted to the rail-facing surface and abutting a portion of the shoulder.

11. The elevator braking apparatus of claim 10, wherein the friction pad is manufactured from a carbon metallic friction material.

12. The elevator braking apparatus of claim 11, wherein, when the friction pad engages an elevator rail during a single slide, the coefficient of friction between the rail and the pad remains relatively constant.

13. The elevator braking apparatus of claim 12, wherein, when the friction pad engages the elevator rail for a plurality of successive slides, the friction pad has an average per slide coefficient of friction that remains relatively constant.

14. The elevator braking apparatus of claim 1, wherein the friction pad has a at a surface having a burnished finish.

15. The elevator braking apparatus of claim 14, wherein the surface has a laser burnished finish.

16. An elevator safety brake comprising:
an elevator safety brake wedge, the wedge having a pad mounting surface and a shoulder protruding from the pad mounting surface;
a friction pad, the friction pad mounted to the pad mounting surface and abutting the shoulder, wherein the friction pad has an average coefficient of friction defined approximately by the following equation:
$$μ = 1.258 * {v}^{- 0.2687}$$
wherein v=the velocity of the brake pad assembly when it first engages an elevator guide rail.

17. The elevator safety brake of claim 16, wherein the friction pad's coefficient of friction remains relatively constant during a single slide along the elevator guide rail.

18. The elevator safety brake of claim 17, wherein the friction pad has a relatively constant average coefficient of friction for multiple slides having similar conditions along the same guide rail.

19. The elevator safety brake of claim 18, wherein the friction pad contains carbon.

20. The elevator safety brake of claim 19, wherein the friction pad is fastened to the safety brake wedge with mechanical fasteners and wherein the shoulder is a rectangularly shaped tab having one surface that abuts the friction pad to carry part of a shear load encountered during a braking application when the friction pad engages an elevator rail.
